(19) United States
(12) Patent Application Publication
(10) Pub. No.: US 2005/0229787 A1
(43) Pub. Date: Oct. 20, 2005

(54) Evaporative emissions canister partition

(76) Inventors: Thomas Charles Meiller, Pittsford, NY (US); Alexander E. Shneydman, Rochester, NY (US)

Correspondence Address: JIMMY L. FUNKE;DELPHI TECHNOLOGIES, INC., P.O. Box 5052, Mail Code: 480-410-202, Troy, MI, 48007-5052, US

(21) Appl. No.: 10/824,451

(22) Filed: Apr. 14, 2004

(51) Int. Cl. B01D 53/02

(52) U.S. Cl. 96/152

(57) ABSTRACT

A device and a method for maintaining composite materials substantially separate within a chamber is shown, which includes, for example, a device for capturing and storing evaporative emissions. The chamber is inside a housing, and contains first and second composite materials. A partition is inserted between the first and second composite materials, and is operable to move within the chamber while maintaining the first composite material substantially separate from the second composite material. The partition permits fluid communication between the first composite material and the second composite material. It also facilitates maintaining composite materials under compression with intent of maintaining evaporative emissions performance over the useful life of the device. This permits use of a common canister package for multiple applications that have varying inputs or varying regulatory requirements.

### TECHNICAL FIELD

This invention pertains generally to a method and device for use in a canister intended to capture and store evaporative emissions from a fuel storage and delivery system of a device, such as a motor vehicle.

### BACKGROUND OF THE INVENTION

Fuel, especially hydrocarbon-based fuel that evaporates from fuel storage and delivery systems contributes a portion of ozone-depleting emissions into the atmosphere. This fuel is typically used to propel engines for motor vehicles and stationary equipment. Regulatory agencies seek to reduce evaporative emissions by requiring vehicle and equipment manufacturers to comply with regulations as a condition for offering their products for sale in the agency's jurisdiction. These regulations have led to the development and implementation of systems that capture evaporative emissions. A substantial portion of the regulatory effort focuses on capturing and controlling evaporative emissions from passenger vehicles with internal combustion engines.

Evaporative emissions are typically generated when stored fuel, generally from a fuel tank or other fuel storage device, evaporates and escapes into the atmosphere. Manufacturers of vehicles and other products that use internal combustion engines are required by law to implement systems that capture a substantial portion of the evaporative emissions and prevent their release into the atmosphere. An evaporative emissions control system is designed to ensure that substantially all fuel vapors from the fuel storage tank of a vehicle are not emitted into the atmosphere, but are captured, stored, and subsequently used by the vehicle, in compliance with regulatory standards. An evaporative emissions control system typically comprises a fuel vapor storage device, referred to as an evaporative canister, with fluid connections to a fuel storage tank and an intake of the internal combustion engine.

The movement of fuel vapors and air from the fuel storage tank to the canister occurs in the following manner. Pressure is created in the fuel storage system by evaporation of the fuel. The fresh air inlet to the canister provides a low pressure point, such that flow of evaporated fuel and air occurs from the fuel storage system, through the canister, and out the fresh air inlet. The intent of the canister design is to adsorb fuel vapor, and permit only air to escape out of the fresh air inlet.

The movement of fuel and air from the canister to the engine occurs in the following manner. A negative pressure is generated in an intake system of an operating engine. The negative pressure causes flow of air from the fresh air inlet through the canister into the engine intake system. This flow of air is typically regulated by a purge control valve, which is controlled by an on-board engine controller. When fresh air flows through the canister, adsorbed fuel vapors are desorbed from the adsorbent material and flowed into the engine intake to be burned by the engine as part of ongoing engine operation. There are other aspects of the evaporative system, including diagnostics and on-board vapor recovery systems that are part of the operation of the evaporative system but not directly affected by the specific invention.

The evaporative canister comprises a sealed impermeable container that typically includes one or more adsorbent materials, or adsorbent devices, that adsorb fuel vapors. The adsorbent materials typically comprise composite carbon-based materials; the adsorbent devices typically include extruded ceramic monolith devices. The composite materials adsorb fuel vapor, or accumulate heat. Evaporated fuel vapors (typically hydrocarbons) are inlet to the canister through a vapor inlet port fluidly attached to the fuel tank. There is a purge port in the canister fluidly attached via tubing to an inlet of the intake of the engine. There is a fresh air inlet to the canister. There are other devices on the canister, including valves and sensors, which are necessary for complete operation and diagnosis of the canister and evaporative system.

The adsorption capacity of a canister depends upon various elements, including the length of the flow path through the canister from the vapor inlet port to the fresh air port, the quantity of adsorption materials, type of adsorption materials used, and packaging and density of the adsorption materials. The adsorption capacity of a canister is primarily based upon an ability of the canister device to cause fuel vapor to physically contact the adsorption materials contained therein. Adsorption capacity and emissions performance decrease with a decrease in composite density, including a decrease in flowpath through the materials. This is due to a decreased likelihood of vapor physically contacting the composite adsorption materials. Therefore, evaporative emissions performance may degrade in a canister with loosely packed adsorption composite materials or with composite materials that become loosely packed over time.

Canister manufacturers address adsorption capacity and emissions performance by using various techniques during assembly to lengthen the flowpath and compress the composite materials. Compression of composite materials may include use of agitating or shaking devices to settle the materials before press-fitting a cap onto the canister to seal the material into a chamber of the canister. They may also employ spring-loaded volume compensating devices in the canister, to adjust effective volume of the material over the useful life of the canister. Lengthening the flowpath may include addition of one or more partitions into a chamber of the canister, thus creating a more circuitous path through the canister.

To meet more stringent regulatory requirements, manufacturers may use multiple chambers in the flowpath of the canister, each containing a type of composite material. Separation of composite materials into multiple chambers is typically accomplished by inserting a separating device into a chamber between composite materials. The separating device may comprise a perforated plate, a rigidly attached partition wall, or some form of filter (e.g. polyester material). A separating device has a tendency to move within the chamber, and may not remain in place over the life of the device. This reduces the ability of the separating device to effectively separate the chambers. As an example, a plate or filter has been shown to rotate within the composite bed during use, leading to commingling of the composite materials. In addition, a canister using various separating devices may not be able to maintain the composite materials in compression over time, thus reducing adsorption effectiveness. Manufacturers have attempted to separate composite materials and maintain the materials in compression using multiple spring devices, or volume compensation devices. The use of multiple compensation devices in a canister increases manufacturing costs and complexity of a canister. Furthermore, different applications may require use of different quantities of the various composite materials to meet differing emissions requirements from different jurisdictions. Use of different quantities of composite materials may lead to use of differently sized packages, each which incurs costs related to design, tooling, testing and validation.

Therefore, what is needed is a canister with a partition device that allows flow between chambers containing composite materials, while keeping the composite materials in separate chambers and maintaining the composite materials at a level of compactness for optimal emissions performance over the device's useful life. There is a need to provide a common package for an evaporative canister, useful in multiple applications. There is a need to reduce package and tooling costs for evaporative canisters, and provide flexibility in packaging different quantities of various composite materials. A common canister package simplifies packaging and assembly of the canister. A common canister package reduces need for testing, development and certification associated with use of multiple canister designs.

### SUMMARY OF THE INVENTION AND ADVANTAGES

The present invention provides an improvement over a conventional canister, especially one that is part of an evaporative emissions control system, by providing a canister package that provides consistent evaporative emissions performance over its useful life. The invention permits use of a common canister package for multiple applications that have varying inputs or varying regulatory requirements. A common canister package reduces need for testing, development and certification associated with use of multiple canister packages on a common vehicle platform. The invention comprises a device and a method for maintaining composite materials contained in an evaporative canister separate and under compression with the intent of maintaining evaporative emissions performance over the useful life of the device.

The present invention includes a device and a method for maintaining composite materials substantially separate within a chamber, for example, a device for capturing and storing evaporative emissions. The chamber is inside a housing, and contains first and second composite materials. A partition is inserted between the first and second composite materials, and is operable to move within the chamber while maintaining the first composite material substantially separate from the second composite material. The partition permits fluid communication between the first composite material and the second composite material.

The present invention further includes the partition for maintaining the first composite material contained within a chamber substantially separate from the second composite material. The partition includes a rigid plate with a plurality of anti-rotation ribs attached. The plate also includes openings and a screen to allow flow of air and fuel vapors. The rigid plate is inserted within the chamber along a plane substantially perpendicular to a longitudinal axis of the chamber. The external dimensions of the rigid plate are slightly less than internal dimensions of the chamber in the plane perpendicular to the longitudinal axis of the chamber. The anti-rotation ribs maintain the rigid plate substantially perpendicular to the longitudinal axis of the chamber as the partition moves within the chamber. Each rib is preferably attached substantially at the outer perimeter of the rigid plate, and is substantially parallel to the longitudinal axis of the chamber. A volume compensation device at an end of the chamber exerts compressive force on the second composite material toward the partition, to compensate for settling of the second composite material that occurs during the useful life of the chamber. The partition moves within the chamber and is able to transfer at least a portion of the compressive force to the first composite material, as against the further end of the chamber. In so doing, the device compensates for material settling of both the first and the second composite materials, and the materials are maintained at a level of compression. This assists in maintaining emissions effectiveness of the first and the second composite materials, and hence the emissions device.

The specific type and quantity of composite materials is determined based upon the quantity of fuel vapors generated by a vehicle or other device during predetermined conditions. The predetermined conditions may comprise, for example, a two-day diurnal test plus a hot soak, or a three-day diurnal test plus a hot soak, or some other conditions. The two-day diurnal test and hot soak, and the three-day diurnal test and hot soak are based upon regulatory agency requirements and are known to one skilled in the art. These and other aspects of the invention will become apparent to those skilled in the art upon reading and understanding the following detailed description of the embodiments.

### BRIEF DESCRIPTION OF THE DRAWINGS

The invention may take physical form in certain parts and arrangement of parts, the preferred embodiment of which will be described in detail and illustrated in the accompanying drawings which form a part hereof, and wherein:

FIG. 1 is a drawing of an evaporative canister, in accordance with the present invention; and,

FIG. 2 is a detail of the partition of the evaporative canister, in accordance with the present invention.

### DETAILED DESCRIPTION OF THE PREFERRED EMBODIMENT

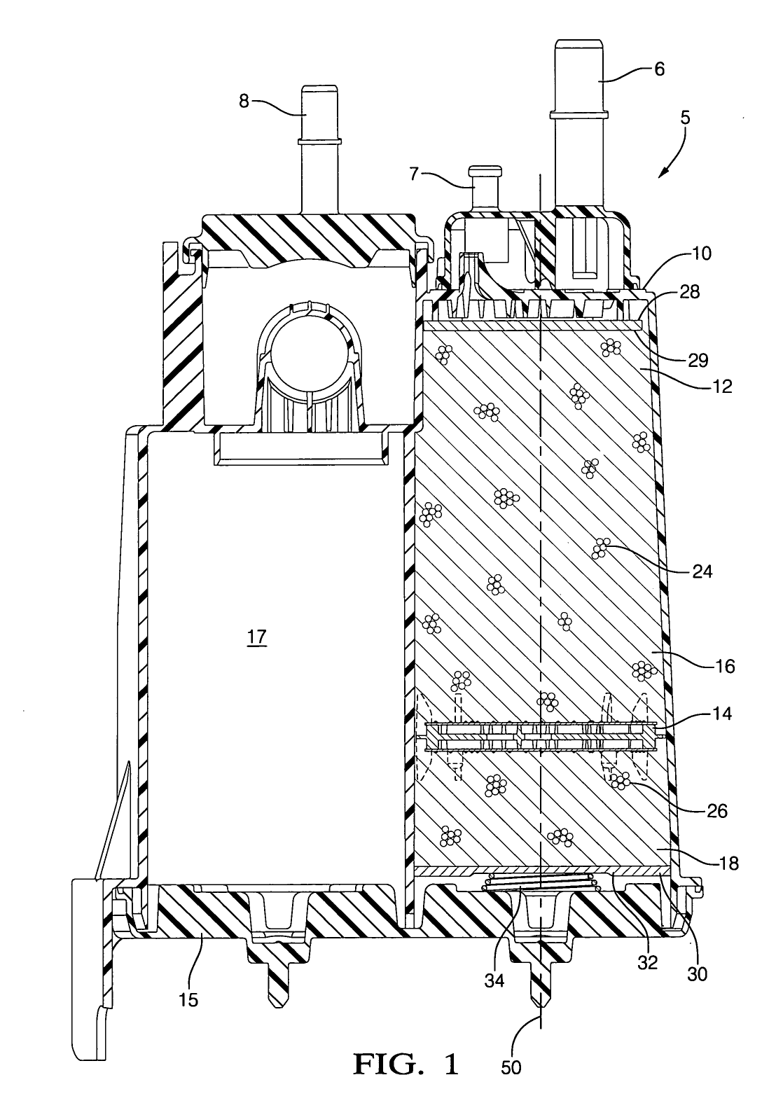

Referring now to the drawings, wherein the showings are for the purpose of illustrating an embodiment of the invention only and not for the purpose of limiting the same, FIG. 1 shows a canister assembly 5 which has been constructed in accordance with the present invention. The canister assembly 5 is an integral component of an evaporative emissions control system that manages fuel vapors for a device with an internal combustion engine, which is used in a motor vehicle in this embodiment. The canister assembly 5 is preferably located in a secure location of the motor vehicle (not shown). Other components of the evaporative emissions control system include a fuel tank; an engine; a fuel system; interconnecting tubing for fluid flow between the engine, the fuel tank and the canister; and sensors, solenoid control valves, and wiring harnesses for controlling flow of air and fuel vapors between the components (not shown). The evaporative system and each of the components are preferably designed to meet various regulatory requirements, including those related to vehicle safety and emissions. Physical requirements for the canister assembly 5 include that material used for a canister housing 10 must resist permeation by various fuel constituents, including gasoline and alcohol. Other physical requirements include that the canister assembly 5 must meet temperature and vibration durability requirements derived based upon the specific vehicle application; and the canister assembly 5 must meet or exceed all applicable safety tests required for the specific vehicle application. Overall design of canister assemblies to meet regulatory, performance, and physical requirements is known to one skilled in the art.

The canister assembly 5 is preferably comprised of the housing 10 fluidly attached to inlets and outlets, several which are described hereinafter. The housing 10 is preferably constructed by molding substantially impermeable material into a predefined configuration. A vapor inlet 6 to the housing 10 of the canister assembly 5 is fluidly attached to the fuel storage tank (not shown) of the vehicle via a flow tube (not shown). There is a purge outlet 7 attached to the housing 10 that permits flow of air and fuel vapors between the canister assembly 5 and an intake system (not shown) of the internal combustion engine (not shown). There is an air inlet 8 to the housing 10 that permits flow of air through the canister assembly 5. The air inlet 8 is typically attached to the air intake system (not shown) of the engine after an air filtering system. The canister assembly may include flow valves and pressure sensors to facilitate complete use and diagnosis of the canister assembly 5 and the evaporative emissions system (not shown). Use of a canister as a component in an evaporative emissions control system is known to one skilled in the art.

Referring again to FIG. 1, the canister assembly 5 in this embodiment preferably comprises the housing 10, including a first chamber 12 and a second chamber 17, and a bottom cover 15. The first chamber 12 comprises an opening within the housing 10 and is fluidly connected to the vapor inlet 6 and the purge outlet 7. The first chamber 12 includes a first end 28, a first subchamber 16 and a second subchamber 18 separated by a partition 14, and a second end 30. The first chamber 12 in this embodiment is preferably tubular in shape with a cross-sectional shape, perpendicular to a longitudinal axis 50 of the chamber, that is trapezoidal and having rounded corners. The first chamber 12 preferably tapers slightly along the longitudinal axis 50, i.e. the major and minor axial dimensions of the rounded trapezoidal cross-section preferably increase linearly from the first end 28 to the second end 30.

The first subchamber 16 is defined by the first end 28, the walls of the first chamber 12, and the partition, and preferably contains a predetermined quantity of a first composite material 24. The second subchamber 18 is defined by the partition 14, the walls of the first chamber 12, and the second end 30, and preferably contains a predetermined quantity of a second composite material 26.

The first and second composite materials 24, 26 are preferably some form of hydrocarbon adsorption material operable to capture and store at least a substantial portion of the quantity of fuel vapors generated from the fuel tank. The first and second composite materials 24, 26 preferably comprise pelletized activated carbon particles that adsorb hydrocarbon molecules onto the surface of each particle. Use of the first and second composite materials 24, 26 described as hydrocarbon adsorption material is generally known to one skilled in the art.

The first end 28 preferably includes a first end plate 29 operable to provide a rigid end to the first chamber 12, keep the first composite material 26 contained within the first chamber 12, and allow air and vapors to flow between the first end 28 and the chamber 12.

The second end 30 is preferably a volume compensation device that typically comprises a volume compensating plate 32 that is rigid, with a compression spring 34 that exerts a compressive force from the bottom cover 15 toward the second composite material 26 contained in the second subchamber 18. The volume compensating plate 32 at the second end 30 is designed to permit flow of air and fuel vapors between the cover 15 and the first chamber 12. The second subchamber 18 floats within chamber 12, as the compression spring 34 exerts compressive normal force against volume compensating plate 32. The compressive force compensates for any settling of the first composite material 24 in the first subchamber 16 or the second composite material 26 in the second subchamber 18. The partition 14 moves within the chamber 12 to accommodate and compensate for any settling of the first composite material 24 in the first subchamber 16.

The second chamber 17 of the housing 10 preferably comprises an opening within the housing 10 adjacent to the first chamber 12, and includes the air inlet 8. The second chamber 17 may contain additional hydrocarbon adsorption material, similar to that stored in the first chamber 12, and may include volume compensation devices and one or more partitions similar to the first chamber. The second chamber may be empty, or it may instead include some form of other device for capturing evaporative emissions.

A preferred flowpath for air and fuel vapors through the canister assembly 5 comprises flow through the vapor inlet 6 and the purge outlet 7 and to the hydrocarbon adsorption material 24 contained in the first subchamber 16. Vapors then pass by the partition 14, to the hydrocarbon adsorption material 26 contained in the second subchamber 18. The air and fuel vapors may then flow past the volume compensating plate 32 at the second end 30 to the cover 15, to the second chamber 17 and to the air inlet 8.

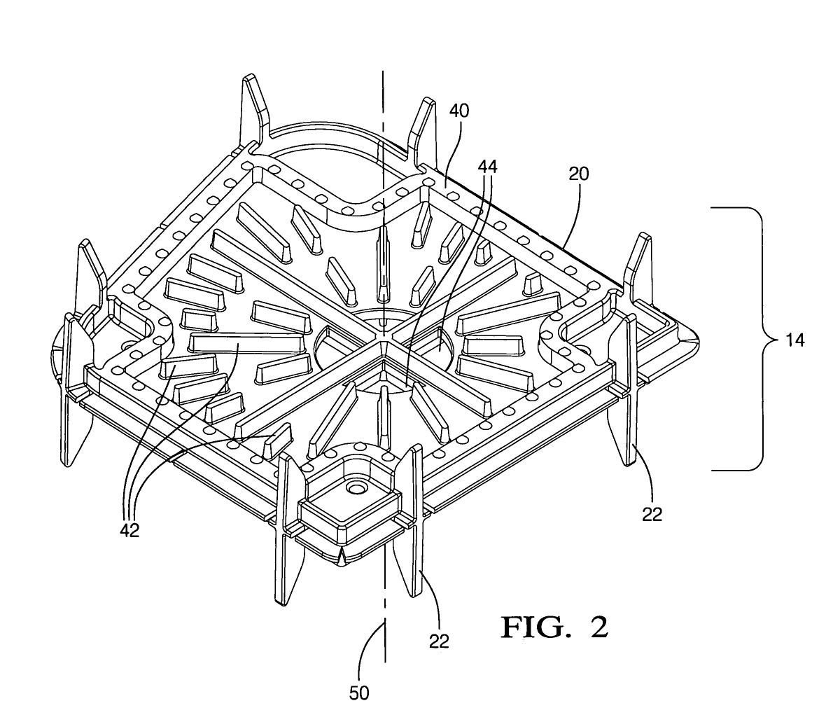

Referring now to FIG. 2 of the invention, the partition 14 of this embodiment comprises a rigid plate 20 with a plurality of anti-rotation ribs 22 rigidly attached thereto. The rigid plate 20 of this embodiment is preferably trapezoidal in shape, with rounded corners, and is designed to conform to the internal shape of the first chamber 12 in the plane substantially perpendicular to the longitudinal axis 50 of the first chamber 12. External linear dimensions of the rigid plate 20 in the trapezoidal plane are slightly less than internal dimensions of the first chamber 12, in the plane perpendicular to the longitudinal axis 50 of the first chamber 12, and accommodate the aforementioned taper of the chamber 12.

Each side of the rigid plate 20 preferably includes a weld pad 40, an elevated grid 42, and one or more openings 44 to permit flow through the rigid plate 20. A permeable screen or filter (not shown) whose area is slightly less than the planar area of the rigid plate 20 is preferably assembled onto the rigid plate 20, is supported by the elevated grid 42, and is attached to the plate 20 at the weld pad 40. The screen (not shown) and partition 14 are designed to permit fluid communication of air and any fuel vapor through the partition 14 while supporting composite materials 24, 26, and substantially preventing movement of composite materials 24, 26 across or through the partition 14. Flow between the first subchamber 16 and the second subchamber 18 may also occur between the outside perimeter of the rigid plate 20 and the walls of the chamber 12.

Each of the plurality of anti-rotation ribs 22 is attached substantially at an outer perimeter of the rigid plate 20, at an angle that is slightly less than substantially perpendicular to the plane of the rigid plate 20. The angle slightly less than perpendicular to the plane of the rigid plate 20 is determined based upon the aforementioned taper of the first chamber 12 along its longitudinal axis 50. In this embodiment, each rib 22 protrudes above and below the plane of the rigid plate 20. When the partition 14 is inserted into the first chamber 12, each of the plurality of ribs 22 is effectively parallel to the longitudinal axis 50 of the first chamber 12, resulting in the rigid plate 20 being maintained substantially perpendicular to the longitudinal axis of the first chamber 12. The partition 14 moves relatively freely within the first chamber 12 such that the plane of the rigid plate 20 is substantially perpendicular to the longitudinal axis 50. The plurality of ribs 22 substantially prevents rotation of the partition 14 within the first chamber 12, relative to the longitudinal axis 50.

Referring again to FIG. 1, the invention is a device and a method to maintain the first composite material 24 substantially separate from the second composite material 26 within the chamber 12. The first composite material 24 is inserted into the first chamber 12 at the first end 28 of the canister housing 10 in canister assembly 5. The partition 14 described hereinabove is inserted thereafter, followed by the second composite material 26. The volume compensation device of the second end 30 is inserted on the second end 30 of the chamber 12, and is operable to exert a compressive force on the second composite material 26 that is substantially parallel to the longitudinal axis 50 of the chamber 12 and preferably substantially normal to the partition 14. The partition 14 fits within the chamber 12 along a plane substantially perpendicular to a longitudinal axis of the chamber 12. The partition 14 is operable to transfer at least a portion of the compressive force exerted by the volume compensation device of the second end 30 of the chamber 12 to the first composite material 24, as against the first end plate 29.

Although this embodiment of the invention is described as a canister assembly 5 which is an integral component of an evaporative emissions control system to manage fuel vapors for a motor vehicle, it is understood that alternate applications and embodiments of this invention may exist. The invention is applicable to a canister chamber and corresponding partition of any cross-sectional shape, including by way of example round, square, oval, rectangular, or other. An alternate embodiment may include a partition with a plurality of ribs that protrude from the plane of the rigid plate in only one direction. It is further understood that this invention includes any partition device used in a canister assembly that is a component of an evaporative emissions control system, whether remotely mounted in the device or mounted inside the fuel tank, or another location.

It is understood that the invention includes any application of a canister assembly used as a component of an evaporative emissions control system for any device, including devices that employ stationary engines, vehicles, and motorized tools. The invention has been described with specific reference to the preferred embodiments and modifications thereto. Further modifications and alterations may occur to others upon reading and understanding the specification. It is intended to include all such modifications and alterations insofar as they come within the scope of the invention.

1. A device for maintaining composite materials substantially separate within a chamber, comprising:
a housing including the chamber, wherein the chamber contains a first composite material, a second composite material, and a partition inserted therebetween;
wherein the partition is operable to move within the chamber while maintaining the first composite material substantially separate from the second composite material; and,
wherein the partition is operable to permit fluid communication between the first composite material and the second composite material.

2. The device of claim 1, wherein the partition comprises a rigid plate with a plurality of ribs attached thereto;
wherein the rigid plate fits within the chamber along a plane substantially perpendicular to a longitudinal axis of the chamber;
wherein external dimensions of the rigid plate are slightly less than internal dimensions of the chamber in the plane perpendicular to the longitudinal axis of the chamber; and,
wherein the plurality of ribs is operable to maintain the rigid plate substantially perpendicular to the longitudinal axis of the chamber.

3. The device of claim 2, wherein each rib is attached substantially at an outer perimeter of the rigid plate.

4. The device of claim 3, wherein each rib is substantially parallel to a longitudinal axis of the chamber.

5. A device for capturing and storing evaporative emissions, comprising a housing; said housing including a chamber containing a first composite material, a second composite material, and a partition therebetween;
wherein the partition substantially separates the first composite material and the second composite material; and,
wherein the partition is operable to move within the chamber while maintaining the first composite material substantially separate from the second composite material.

6. The device of claim 5, wherein the partition is operable to permit fluid communication between the first composite material and the second composite material.

7. The device of claim 6, wherein the partition comprises a rigid plate with a plurality of ribs attached thereto;
wherein the rigid plate fits within the chamber along a plane substantially perpendicular to a longitudinal axis of the chamber;
wherein external dimensions of the rigid plate are slightly less than internal dimensions of the chamber in the plane perpendicular to the longitudinal axis of the chamber; and,
wherein the plurality of ribs is operable to maintain the rigid plate substantially perpendicular to the longitudinal axis of the chamber.

8. The device of claim 7, wherein each rib is attached substantially at an outer perimeter of the rigid plate.

9. The device of claim 8, wherein each rib is substantially parallel to a longitudinal axis of the chamber.

10. The device of claim 5, further comprising a first end and a second end of the chamber; wherein the second end of the chamber comprises a device operable to exert a compressive force on the second composite material.

11. The device of claim 10, wherein the partition is operable to transfer at least a portion of the compressive force exerted by the second end of the chamber to the first composite material.

12. The device of claim 11, wherein the first composite material is operable to capture and store at least a portion of evaporative emissions.

13. The device of claim 12, wherein the second composite material is operable to capture and store at least a portion of evaporative emissions.

14. A partition for maintaining a first composite material substantially separate from a second composite material within a chamber, comprising:
a rigid plate with a plurality of ribs attached thereto;
wherein the rigid plate is inserted within the chamber along a plane substantially perpendicular to a longitudinal axis of the chamber;
wherein external dimensions of the rigid plate are slightly less than internal dimensions of the chamber in the plane substantially perpendicular to the longitudinal axis of the chamber;
wherein the plurality of ribs is operable to maintain the rigid plate substantially perpendicular to the longitudinal axis of the chamber; and,
wherein the partition is operable to move within the chamber.

15. The partition of claim 14, wherein each rib is attached substantially at an outer perimeter of the rigid plate.

16. The partition of claim 15, wherein each rib is substantially parallel to the longitudinal axis of the chamber.

17. The partition of claim 14, wherein the partition is operable to move within the chamber comprises: the partition is operable to transfer at least a portion of a compressive force exerted on the second composite material to the first composite material.

18. The partition of claim 17, wherein the partition is operable to permit fluid communication between the first composite material and the second composite material.

19. The partition of claim 18, wherein the first composite material is operable to capture and store at least a portion of evaporative emissions.

20. A method to maintain a first composite material substantially separate from a second composite material, each contained within a chamber, comprising:
inserting a partition into the chamber between the first composite material and the second composite material;
wherein said partition is operable to move within the chamber while maintaining the first composite material substantially separate from the second composite material;
wherein said partition comprises a rigid plate with a plurality of ribs attached thereto;
wherein the rigid plate fits within the chamber along a plane substantially perpendicular to a longitudinal axis of the chamber;
wherein external dimensions of the rigid plate are slightly less than internal dimensions of the chamber in the plane substantially perpendicular to the longitudinal axis of the chamber;
wherein each rib is attached substantially at an outer perimeter of the rigid plate;
wherein each rib is substantially parallel to the longitudinal axis of the chamber; and,
wherein the plurality of ribs is operable to maintain the rigid plate substantially perpendicular to the longitudinal axis of the chamber.
